(19) United States
(12) Patent Application Publication
(10) Pub. No.: US 2010/0250752 A1
(43) Pub. Date: Sep. 30, 2010

(54) COMMUNICATION APPARATUS, METHOD OF STARTING COMMUNICATION APPARATUS, AND COMPUTER READABLE STORAGE MEDIUM

(75) Inventors: Takeshi ISHIHARA, Yokohama-Shi (JP); Nobuhiko Sugasawa, Kawasaki-Shi (JP); Kensaku Yamaguchi, Kawasaki-Shi (JP); Keisuke Mera, Kawasaki-Shi (JP); Yuichiro Oyama, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/561,728

(22) Filed: Sep. 17, 2009

(30) Foreign Application Priority Data
Mar. 24, 2009 (JP) 2009-071400

(51) Int. Cl. G06F 15/16

(52) U.S. Cl. 709/227

(57) ABSTRACT

A communication apparatus, comprising has a generator which generates format information of a start instruction message, a memory which stores the format information, a communication unit which transmits the format information and receives a start instruction message via a network, and a controller which detects whether or not the received start instruction message corresponds to the format information stored in the memory, and performs start processing and initialization processing based on a content of the start instruction message when the received start instruction message corresponds to the format information.

### CROSS REFERENCE TO RELATED APPLICATION

This application is based upon and claims benefit of priority from the Japanese Patent Application No. 2009-71400, filed on Mar. 24, 2009, the entire contents of which are incorporated herein by reference.

### BACKGROUND OF THE INVENTION

The present invention relates to a communication apparatus, a method of starting a communication apparatus and a computer readable storage medium.

A technique for remotely starting a communication apparatus which is in a sleep mode (a standby state) via a network is already well known. In this technique, a user first sends a start instruction to the communication apparatus. When the start instruction is received, the communication apparatus supplies electric power to all components and performs initialization processing. When initialization processing is completed, the communication apparatus enters a state of waiting for a remote operation instruction via a network. In this manner, the user can operate the communication apparatus via a network. However, since all components are initialized, the user had to wait for a long time until a desired service is available. Further, since electric power is supplied even to a component which is not necessary for service provision, there was a problem in that power consumption of the communication apparatus increases.

In order to resolve the problem, an apparatus which includes a main processor which operates in a normal mode and stops in an energy saving mode and a sub processor which is lower in power consumption than the main processor, stops in the normal mode and operates in the energy saving mode has been suggested (see, for example, JP-A 2005-267100 (KOKAI)). The sub processor performs processing with small computation cost in the energy saving mode, and when processing with large computation cost needs to be performed, the main processor is operated to initiate the normal mode. When this apparatus is used, power consumption is reduced. Further, since part of processing is performed by the sub processor, responsiveness at the time of stopping the main processor is improved.

However, even if the apparatus described above is used, when a service desired by a user needs processing which is performed by the main processor, starting of the main processor has to be waited, and thus a standby time cannot be reduced. Further, when the main processor starts, since the whole apparatus needs to start, power consumption cannot be reduced.

### SUMMARY OF THE INVENTION

According to one aspect of the present invention, there is provided a communication apparatus, comprising:

a generator which generates format information of a start instruction message;

a memory which stores the format information;

a communication unit which transmits the format information and receives a start instruction message via a network; and

a controller which detects whether or not the received start instruction message corresponds to the format information stored in the memory, and performs start processing and initialization processing based on a content of the start instruction message when the received start instruction message corresponds to the format information.

According to one aspect of the present invention, there is provided a method of starting a communication apparatus, comprising:

at a communication unit, receiving an acquisition request for a format of a start instruction message;

at a generator, generating a format based on an internal state;

at the communication unit, notifying the format;

at the communication unit, receiving a start instruction message corresponding to the format; and

at a controller, performing start processing and initialization processing for a component instructed by the received start instruction message among a plurality of components.

According to one aspect of the present invention, there is provided a computer-readable storage medium storing a program of starting a communication apparatus which causes a computer to execute the steps of:

at a communication unit, receiving an acquisition request for a format of a start instruction message;

at a generator, generating a format based on an internal state;

at the communication unit, notifying the format;

at the communication unit, receiving a start instruction message corresponding to the format; and

at a controller, performing start processing and initialization processing for a component instructed by the received start instruction message among a plurality of components.

### BRIEF DESCRIPTION OF THE DRAWINGS

FIG. 1 is a schematic configuration view of a communication apparatus according to a first embodiment;

FIG. 2 is a schematic diagram of a network environment using the communication apparatus according to the first embodiment;

FIG. 3 is a sequence diagram for explaining operation of the communication apparatus according to the first embodiment;

FIG. 4 is a view illustrating an example of a storage form of a message format and a parameter;

FIGS. 5A to 5E are views illustrating a configuration example of a start instruction message;

FIG. 6A is a view illustrating a configuration example of a start instruction message;

FIG. 6B is a view illustrating an example of start information of a text form;

FIG. 7 is a sequence diagram explaining an operation example when a communication apparatus generates a message format;

FIG. 8 is a sequence diagram explaining an operation example when a communication apparatus generates a message format;

FIG. 9 is a sequence diagram explaining an operation example when a communication apparatus generates a message format;

FIG. 10 is a view illustrating a description example of a start format acquisition response;

FIG. 11 is a sequence diagram for explaining a communication method according to a second embodiment;

FIG. 12 is a sequence diagram for explaining a communication method according to a modified embodiment;

FIG. 13 is a view illustrating an example of a storage form of a message format and an MAC address;

FIG. 14 is a view illustrating an example of a storage form of a message format, an MAC address and a parameter;

FIG. 15 is a view illustrating an example of a storage form of a message format and an MAC address according to a third embodiment;

FIG. 16 is a schematic configuration view of a communication apparatus according to a fourth embodiment;

FIG. 17 is a sequence diagram for explaining operation of the communication apparatus according to the fourth embodiment;

FIG. 18 is a sequence diagram for explaining operation of the communication apparatus according to the fourth embodiment;

FIG. 19 is a schematic diagram of a network environment using the communication apparatus according to a fifth embodiment;

FIG. 20 is a sequence diagram for explaining operation between communication apparatuses according to a fifth embodiment;

FIG. 21 is a view illustrating a configuration example of a start instruction message;

FIGS. 22A and 22B are views illustrating a configuration example of a start instruction message;

FIG. 23 is a sequence diagram for explaining operation of the communication apparatus according to the fifth embodiment; and

FIG. 24 is a sequence diagram for explaining operation of the communication apparatus according to the fifth embodiment.

### DESCRIPTION OF THE EMBODIMENTS

Hereinafter, embodiments of the present invention will be described with reference to the accompanying drawings.

### First Embodiment

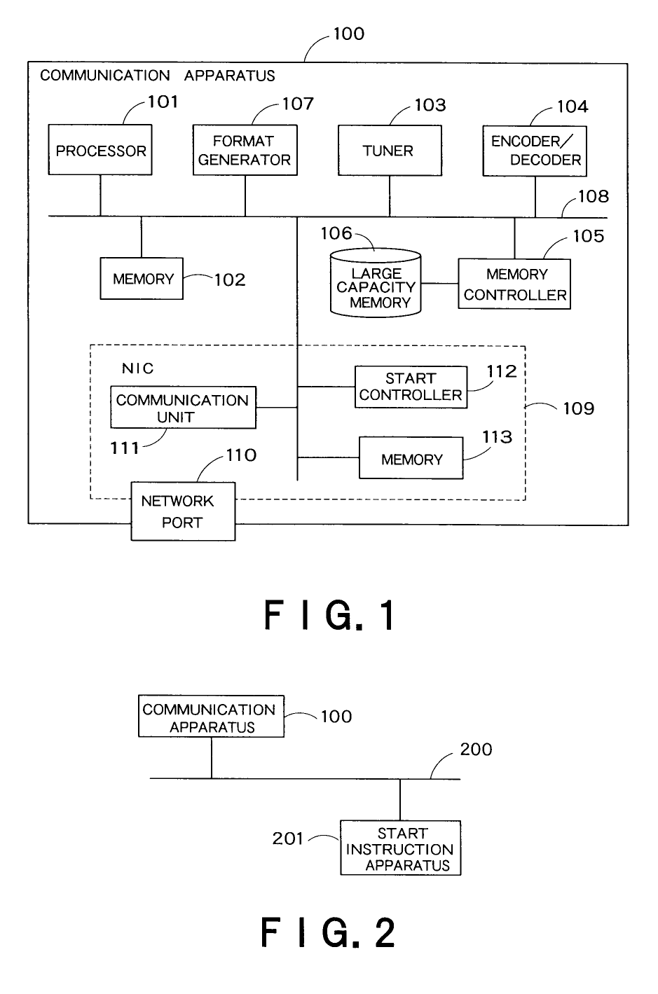

FIG. 1 illustrates a schematic configuration of a communication apparatus according to a first embodiment of the present invention. The first embodiment will be described focusing on a case in which a communication apparatus is a broadcasting recording apparatus with a network function.

A communication apparatus 100 includes a processor 101, a memory 102, a tuner 103, an encoder/decoder 104, a memory controller 105, a large capacity memory 106, a format generator 107, and a network interface card (hereinafter, referred to as “NIC”) 109. The NIC 109 includes a network port 110, a communication unit 111, a start controller 112, and a memory 113. The respective components of the communication apparatus 100 are connected through a bus 108.

The processor 101 controls the communication apparatus 100 or operates a variety of application software for realizing a provided service.

The memory 102 stores data which is processed by an application executed by the processor 101. The memory 102 is, for example, a random access memory (RAM).

The tuner 103 receives a broadcasting signal.

The encoder/decoder 104 decodes a broadcasting signal received by the tuner 103 and encodes the broadcasting signal into a record format of the large capacity memory 106.

The memory controller 105 controls the large capacity memory 106.

The large capacity memory 106 stores a broadcasting signal which is received by the tuner 103 and converted into an appropriate format through the encoder/decoder 104. The large capacity memory 106 is, for example, a hard disc or a flash memory.

The format generator 107 generates a format of a packet (a start instruction message) necessary for starting the communication apparatus 100 from the outside (a remote site). The format will be described later. The communication apparatus 100 can be remotely started only through the start instruction message with the format.

The network port 110 physically connects the communication apparatus 100 with an external network. The external network may be a wire-line network or a wireless network.

The communication unit 111 performs control between a signal flowing through a network and the communication apparatus 100.

The start controller 112 determines whether or not the start instruction message received through the network port 110 matches with (corresponds to) the format generated by the format generator 107. The start controller 112 also performs power control and initialization of the respective components of the communication apparatus 100 based on the determination result.

The memory 113 temporarily stores a signal received through the network port 110. The memory 113 also stores the format generated by the format generator 107. The memory 113 is, for example, a RAM.

FIG. 2 is a schematic diagram of a network environment using the communication apparatus 100. The communication apparatus 100 is connected to a start instruction apparatus 201 via a network 200. The network 200 is a network such as, for example, Ethernet (registered trademark). The start instruction apparatus 201 transmits the start instruction message to the communication apparatus 100 and requests the communication apparatus 100 to start.

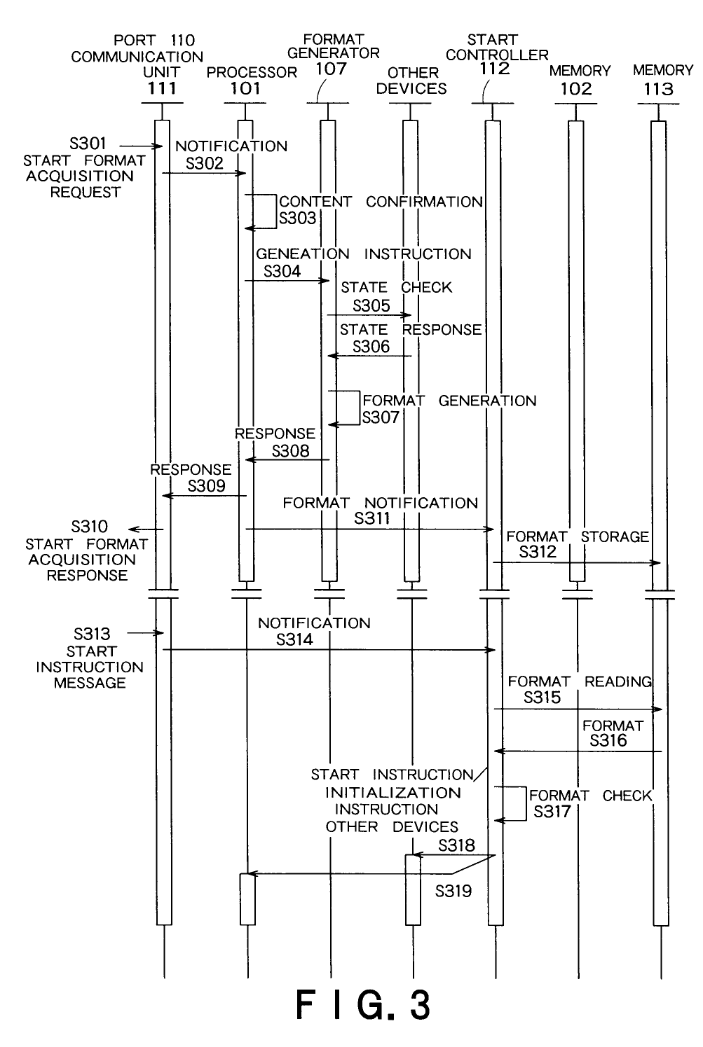

FIG. 3 illustrates an operation sequence of the communication apparatus 100 in the network environment illustrated in FIG. 2. Referring to FIG. 3, a part surrounded by a rectangular frame represents a state in which a corresponding component is powered on, and a part which is not surrounded by a rectangular frame represents at state in which a corresponding component is powered off.

In step S301, the start instruction apparatus 201 transmits a start format acquisition request to the communication apparatus 100 and requests a format of a start instruction message. The communication unit 111 of the communication apparatus 100 receives the start format acquisition request through the network port 110.

In step S302, the communication unit 111 notifies the received start format acquisition request to the processor 101.

In step S303, the processor 101 processes the start format acquisition request and confirms that the format of the start instruction message has been requested from the start instruction apparatus 201.

In step S304, the processor 101 instructs the format generator 107 to generate the format of the start instruction message.

In steps S305 and S306, the format generator 107 which has received the format generation instruction checks configurations or states of the respective components which configure the communication apparatus 100. For example, the format generator 107 checks information of channels which the tuner 103 is able to receive, a conversion method or a bit rate supported by the encoder/decoder 104, the number of the large capacity memories 106, or the available capacity of the large capacity memory 106. The number of the large capacity memories 106 means that a large capacity memory can be added or removed.

When the states or configurations of the respective components are checked, in the case in which the start instruction apparatus 201 has a selection right in start processing and initialization processing subsequent thereto, a range of a selectable value may be investigated. For example, the tuner 103 has parameters such as a type of receivable broadcasting or a range of a channel. These parameters may be selected at the transmission side of the start instruction message, and so the start instruction apparatus 201 may transmit a content of a desired service together with the start instruction message.

When information included in an operating system (OS) can be used, steps S305 and S306 may be omitted.

In step S307, the format generator 107 generates the format of the start instruction message based on a predetermined generation rule. Details of the generated format will be described later.

In step S308, the format generator 107 notifies the generated format to the processor 101. When the start instruction apparatus 201 has the selection right as described above, a range of a settable value may be notified together.

In step S309, the processor 101 notifies the format received from the format generator 107 to the communication unit 111.

In step S310, the communication unit 111 transmits the format received from the processor 101 to the start instruction apparatus 201 via the network port 110 as a start format receiving response.

In step S311, the processor 101 notifies the format received from the format generator 107 to the start controller 112.

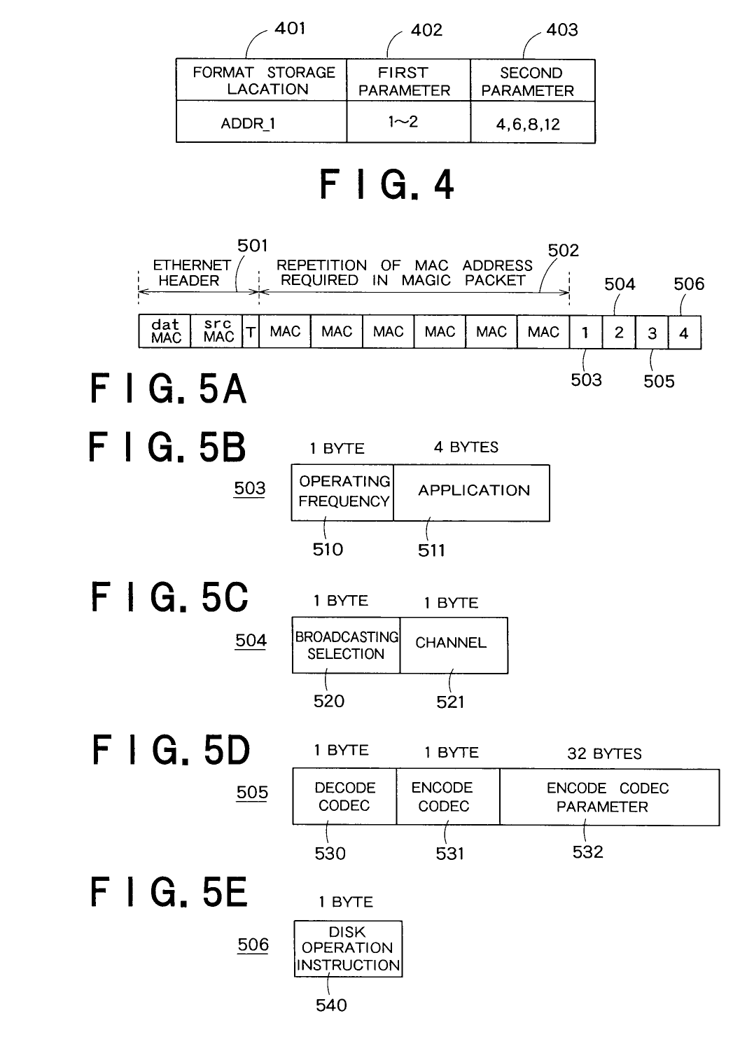

In step S312, the start controller 112 stores the format received from the processor 101 in the memory 113. When the selection right is given to the start instruction apparatus 201, a range of a selectable value may be stored in the memory 113 in association with the corresponding message format. For example, as illustrated in FIG. 4, an address 401 in which the format is stored is stored in the memory 113 in association with a range 402 of a first parameter and a range 403 of a second parameter which are included in the format.

Even though the selection right is given, when the selectable range is determined as a fixed value in designing, the selectable range may not be stored.

After step S312 is finished, when there is no service which the communication apparatus 100 has to provide, the communication apparatus 100 enters a power off state (a standby state). Here, components except the NIC 109 are powered off.

In step S313, the start instruction apparatus 201 transmits the start instruction message, which is based on the format received in step S310, to the communication apparatus 100 in order to use a service provided from the communication apparatus 100.

When the format is received, in the case in which the selection right is given, the start instruction apparatus 201 selects an appropriate value and includes the selected value in a predetermined location of the start instruction message.

In step S314, the communication unit 111 receives the start instruction message through the network port 110 and notifies the received start instruction message to the start controller 112.

In Steps S315 and S316, the start controller 112 reads out the format from the memory 113.

In step S317, the start controller 112 determines whether or not the received start instruction message matches with the format read out from the memory 113. This determination processing will be described later. The start controller 112 performs subsequent processing when the start instruction message matches with the format but finishes processing when the start instruction message does not match with the format. Here, it is assumed that the start instruction message matches with the format.

In steps S318 and S319, the start controller 112 supplies electric power to a component, which is instructed to be powered on, among the components of the communication apparatus 100 to start the component while performing initialization, based on the content included in the start instruction message. Therefore, a service of the communication apparatus 100 becomes available. Details of start and initialization processing will be described later.

The details of determination processing about whether or not to power on depend on a message format which is previously exchanged. That is, a power on instruction may be expressly included in a message format, or a power on instruction may be implicitly performed according to a presence of a field corresponding to a component.

In the case in which the instruction is expressly included, on/off determination is performed based on a value of a corresponding field. In the case in which the instruction is implicitly included, only a component included as an initialization instruction target is powered on.

However, power control is performed depending on a detailed power design of an apparatus. For example, two components may be individually connected to a single power line. In this case, even though one component is instructed to be powered on through the start instruction message, both components are powered on. For this design restriction, the format generator 107 may generate the format in view of the restriction, the start controller 112 may perform power control in view of the restriction, or power may be implicitly turned on.

The communication apparatus 100 basically operates as described above. As described above, the communication apparatus 100 stores the format in the memory 113 and thereafter transitions to a power off state. However, the communication apparatus 100 may transition to a different power state and then return through the start instruction message from the start instruction apparatus 201. As the different power state, for example, a suspend state (a state in which the NIC 109 and the memory 102 are powered on but the other components are powered off) may be considered.

Next, a format of a packet which is exchanged between the communication apparatus 100 and the start instruction apparatus 201 will be described. As described above, as packets exchanged between the communication apparatus 100 and the start instruction apparatus 201, there are three types, that is, the start format acquisition request transmitted from the start instruction apparatus 201 during operation of the communication apparatus 100, the start format acquisition response transmitted from the communication apparatus 100 according to the start format acquisition request, and the start instruction message through which the start instruction apparatus 201 requests the communication apparatus 100 to return from a power off state.

Of the three types of packets, the former two packets may employ an arbitrary packet format. For example, when a web server operates through the processor 101, a hyper text transfer protocol (HTTP) may be used as a transporter to exchange an arbitrary format. As an example, an arbitrary format may be exchanged through a text message configured by a mark-up language. At this time, when the web server supports encryption, a hyper text transfer protocol secure (HTTPS) in which encryption processing is performed may be used. This can be identically applied to a case in which a text-based protocol other than a HTTP is used.

Further, a protocol in which the format is exchanged by binary data may be specified to be used. Further, a protocol in which a command is instructed on a text basis and a generated message format is received on a binary basis may be used. As a protocol used to exchange the format of the start instruction message, an arbitrary protocol may be used.

Meanwhile, the start instruction message uses a format designated by the communication apparatus 100. A range to be designated by the format depends on the capability of the communication unit 111 or the start controller 112 which configures the communication apparatus 100. A designatable range is restricted to a layer higher than a data link layer. For the data link layer, a format specified by a communication media of a network to which the communication apparatus 100 is connected has to be used. For example, in the case in which a wire-line Ethernet is used, a frame format specified in IEEE 802.3 has to be used, while in the case in which a wireless local area network (WLAN) is used, a frame format specified in IEEE 802.11 has to be used.

When the communication unit 111 or the start controller 112 has the capability of recognizing an arbitrary frame format as the start instruction message, any format may be used in a part higher than an Ethernet header. For example, an area for individually storing power instruction or initialization information corresponding to a component may be defined behind a data part of a magic packet form (a part in which an MAC address is repeated six times), and a message of a text form based on a mark-up language may be used. The start instruction message may be defined as a typical TCP/IP packet.

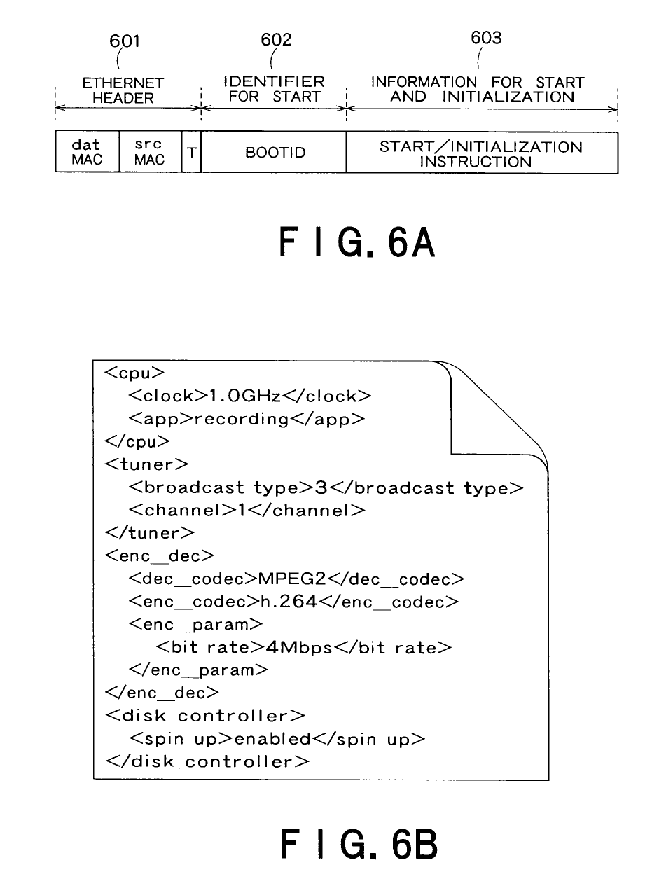

FIGS. 5A to 5E and FIGS. 6A and 6B illustrate start instruction messages for executing recording processing in the communication apparatus 100. FIGS. 5A to 5E illustrate an example of a binary form, and FIGS. 6A and 6B illustrate an example of a text form. Contents designated in respective fields which configure both messages are exemplary, and the present invention is not limited to them.

As illustrated in FIG. 5A, a start identifier based on a magic packet is employed in the start instruction message, and an MAC address of a node to be started is continuously repeated six times 502 behind an Ether header 501.

An area corresponding to a format generated by the format generator 107 is continued behind the MAC address. This area includes four parts, that is, a start/initialization instruction 503 for the processor 101, a start/initialization instruction 504 for the tuner 103, a start/initialization instruction 505 for the encoder/decoder 104, and a start/initialization instruction 506 for the memory controller 105.

In the drawings, it is assumed that a power-on instruction for a component is implicitly expressed according to a presence of a field. That is, in FIGS. 5A to 5E, since an instruction content for the format generator 107 is not included, the start controller 112 does not perform processing for the format generator 107 in the sequence (step S318) of from start to initialization.

As illustrated in FIG. 5B, the start/initialization instruction 503 for the processor 101 includes an operating frequency indication 510 and an operating application indication 511. The operating frequency indication 510 may have a form in which a number is directly designated or a form in which a certain number corresponds to a certain operating frequency (for example, a binary number 111 denotes 1.0 GHz).

Similarly, the application indication 511 may be a value representing a certain application, a corresponding file name/program name, or an address of a memory which can be directly used as a program counter.

As illustrated in FIG. 5C, the start/initialization instruction 504 for the tuner 103 includes a type 520 of broadcasting which has to receive and a channel 521 which has to be received from broadcasting of a corresponding type. Similarly to the start/initialization instruction 503 for the processor 101, a code value may be designated, or a channel number may be directly designated in the case of a channel designation.

As illustrated in FIG. 5D, the start/initialization instruction 505 for the encoder/decoder 104 includes a designation 530 of a codec needed for a decoder to interpret an input, a designation 531 of a codec used by an encoder, and an encoding parameter 532. Similarly to the cases described above, the fields may include a code value or be designated a value which can be directly used. For example, a directly used value may be designated as a bit rate.

As illustrated in FIG. 5E, the start/initialization instruction 506 for the memory controller 105 includes an operation instruction 540 for the large capacity memory 106 which is connected thereto. This corresponds to, for example, a spin-up instruction of a disk.

In the start instruction message of a text form, a start identifier 602 which is different from a magic packet is included behind an Ethernet header 601 as illustrated in FIG. 6A. As the start identifier 602, for example, a random number generated by the format generator 107 or a time at which the format is generated may be used. A field 603 behind the start identifier 602 includes information of a text form for start/initialization.

FIG. 6B illustrates an example of the start information 603 of a text form in which a mark-up language is used. Setting information expressed as contents of respective tags is identical to as in an example of the start instruction message of a binary form illustrated in FIGS. 5A to 5E.

A restriction (a settable field representing which of a text form and a binary form is employed) for a format of a series of start instruction messages is specified in the format generator 107 when designed. The format generator 107 may be designed to correspond to a plurality of message formats. In this case, information for restricting to a packet format which can be generated by the start instruction apparatus 201 may be included in the start format acquisition request transmitted in step S301, and the format generator 107 may determine a format of the start instruction message which is sent back, based on the information.

As described above, when a process of selecting an available one from a plurality of formats is included, there is a case in which processing is not completed in a series of steps described in FIG. 3. For example, a format of a start message required through the start format acquisition request which the start instruction apparatus 201 transmits in step S301 may not be corresponded in the communication apparatus 100. In this case, a message needs to be exchanged twice or more times to continue processing.

Next, the start format acquisition response transmitted from the communication apparatus 100 to the start instruction apparatus 201 will be described. As a protocol of the response, an arbitrary protocol may be used. Here, a description method of the format will be described.

In order to share a format between the communication apparatus 100 and the start instruction apparatus 201, two methods may be employed. A first method is a method of selecting an appropriate one from among a plurality of formats which are shared in advance. A second method is a method of using, for example, an XML document to notify a structure and meaning together.

The first method may be employed when the communication apparatus 100 and the start instruction apparatus 201 store format candidates inside in advance. In this case, an identifier for identifying a corresponding format may be included in a message which is transmitted in step S310 as the start format acquisition response.

For example, in the case in which formats illustrated in FIGS. 5A to 5E and FIGS. 6A and 6B are stored inside in advance, when an identifier “1” is included in the start format acquisition response, the format illustrated in FIGS. 5A to 5E is used, while when an identifier “2” is included, the format illustrated in FIGS. 6A and 6B is used. When the start instruction apparatus 201 has a right for selecting a value, the information has to be separately notified.

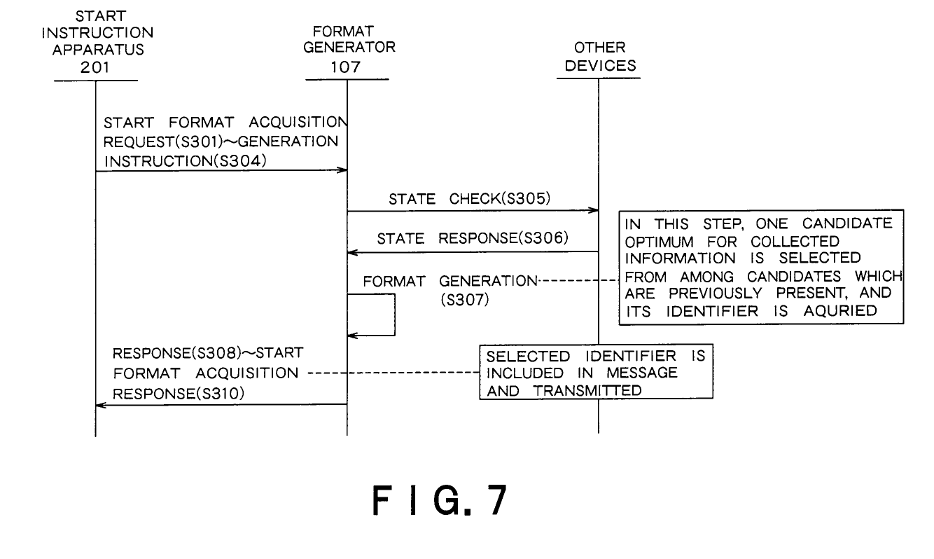

FIG. 7 illustrates a simplified sequence of from the time of transceiving the start format acquisition request to the time of transceiving the start format acquisition response between the start instruction apparatus 201 and the communication apparatus 100 in the case of employing this method.

The second method may be used even in the case in which format candidates of the start instruction message are not shared between the communication apparatus 100 and the start instruction apparatus 201. However, at least a form of transmitting a structure and meaning has to be agreed between the communication apparatus 100 and the start instruction apparatus 201. For example, an agreement in which an XML is used for notification is needed.

When the second method is employed, two types of information may be included in a message replied in step S310 as the start format acquisition response.

As first information, the format generator 107 generates a document for transmitting a structure and meaning of the start instruction message. In this case, the format generator 107 may be required to have a sufficient function and processing capability.

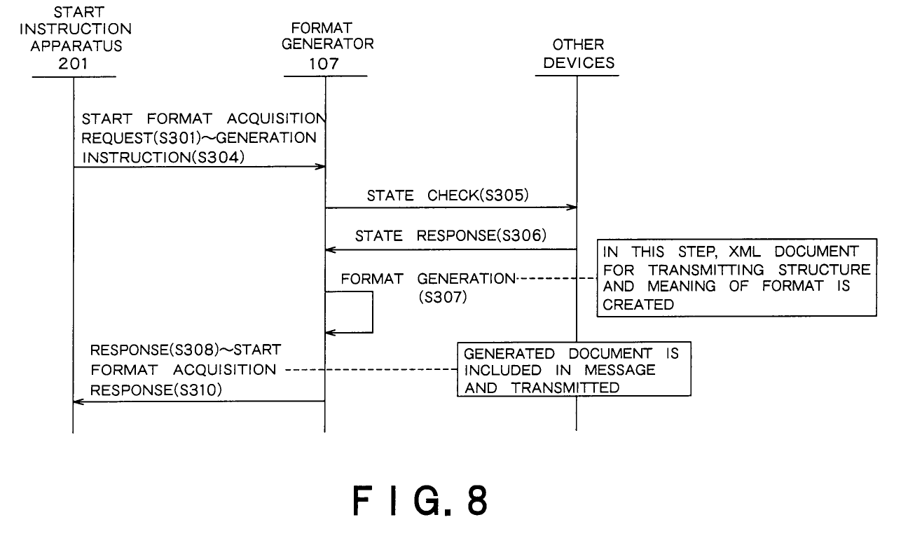

FIG. 8 illustrates a simplified sequence of from the time of transceiving the start format acquisition request to the time of transceiving the start format acquisition response between the start instruction apparatus 201 and the communication apparatus 100 in the case of employing this method.

As second information, the format generator 107 does not generate a document for transmitting a structure and meaning of a start instruction message but inserts a location of corresponding information. For example, the communication apparatus 100 notifies a current internal state to a server apparatus provided by a development source of the communication apparatus 100, and based on this, the server apparatus generates and accumulates a document for transmitting a structure and meaning. The internal state of the communication apparatus 100 refers to information such as a power state (for example, an operation mode such as power on/off or suspended) and an operation state (setting of receiving broadcasting and channel in the case of a tuner, a codec and a parameter in the case of a decoder, or information about whether or not a disc is rotating in the case of a disc controller) of the respective components of the communication apparatus 100, and information about other states which can be employed by the respective components.

The server apparatus notifies a uniform resource identifier (URI) which identifies a document accumulated in the server to the communication apparatus 100. The communication apparatus 100 includes the received URI in the start format acquisition response. In this method, the format generator 107 is required not to have the high capability such as format definition generation and but to have the capability of collecting information of the respective components.

The start instruction apparatus 201 which has received the start formation acquisition response with the URI access the corresponding URI to acquire the format of the start instruction message accumulated in the server.

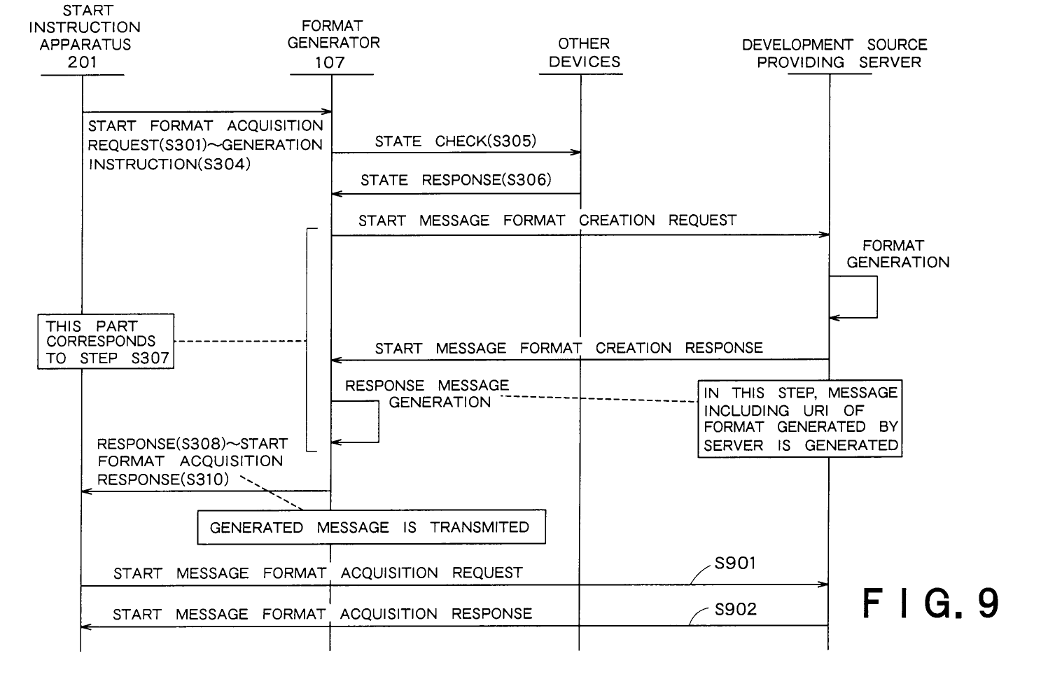

FIG. 9 illustrates a simplified sequence of from the time of transceiving the start format acquisition request to the time of transceiving the start format acquisition response between the start instruction apparatus 201 and the communication apparatus 100 in the case of employing this method. In this case, the start instruction apparatus 201 receives the start format acquisition response (S310) and thereafter accesses the development source providing server to acquire the format (steps S901 and S902).

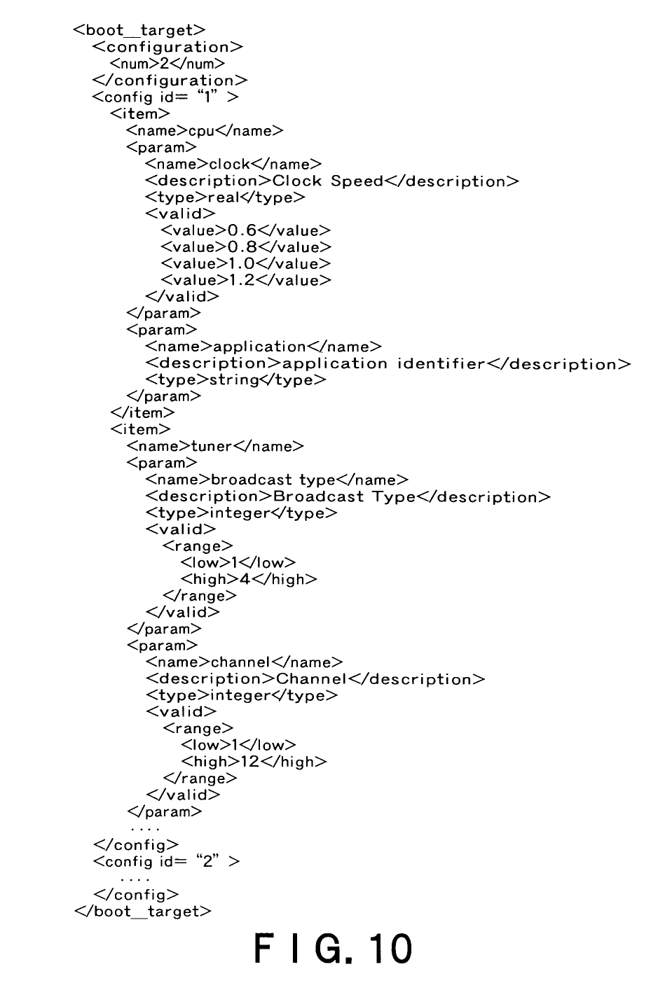

FIG. 10 illustrates a description example in the case in which the format of the start instruction message is notified to the start instruction apparatus 201 in a mark-up language.

Next, processing of checking whether or not the start instruction message received from a remote site (the start instruction apparatus 201) matches with the format generated by the format generator 107, which is performed in step S317, will be described.

Contents of checking processing change depending on the format of the start instruction message or the processing capability of the start controller 112.

For example, when the start instruction message of the binary form is used and the processing capability of the start controller 112 is low, only the length of the message may be checked. When the processing capability of the start controller 112 is increased, checking whether or not a setting parameter for a component which can be selected by the start instruction apparatus 201 is within a predetermined range is performed.

A range of a setting parameter used as a reference at the time of checking processing is stored in the memory 113 as a result of checking a state of each component through the format generator 107 in steps S305 and S306 or set as a fixed range to the start controller 112 when designed.

When the start instruction message of the text form such as the mark-up language is used, it is meaningless to simply compare the length of the message. For this reason, for example, when the mark-up language is used, checking whether or not all necessary tags are included or whether or not a setting parameter of a component designated by a tag is within a predetermined range may be performed. A reference range of the setting parameter is identical to as in the case of the binary form described above.

Next, power control and initialization of the respective components through the start controller 112 will be described. Operation of the start controller 112 will be described using the start instruction message illustrated in FIGS. 5A to 5E. The start instruction message includes the start/initialization instruction for the processor 101, the start/initialization instruction for the tuner 103, the start/initialization instruction for the encoder/decoder 104, and the start/initialization instruction for the memory controller 105.

The start controller 112 regards that the received message has the format illustrated in FIGS. 5A to 5E with reference to the format stored in the memory 113 and performs processing.

In this example, when it is determined that the start instruction message has four components, electric power is controlled to be supplied to the respective components.

Subsequently, setting for components corresponding to information included in the respective filed of the start instruction message is performed. For example, the start controller 112 performs processing of taking a value out of the operating frequency field 510 included in the start/initialization instruction 503 corresponding to the processor 101 and writing the value into a predetermined register of the processor 101.

In a similar manner, the start controller 112 takes a value out of the application designation field 511 and instructs execution of an application corresponding to the processor 101. This processing may directly designate an address of a memory in which a corresponding application is loaded as a program counter. Alternatively, an implementation method of writing an application identifier (for example, a file name) into a certain area which can be referred to by an operating system (OS) and starting operation of the application after operation of the OS restarts may be considered.

In the present embodiment, an order of initial setting is particularly not limited. However, in an actual program, for example, timing in which an operating frequency can be changed may be designated. In this case, an order of start processing performed by the start controller 112 needs to be appropriately determined. The order is determined by the format generator 107 and stored in the memory 113 together with the message format. Information used to determine the order through the format generator 107 is well-known information which is determined when designed.

The start controller 112 performs initialization for other devices in a similar manner. An initialization process is basically performed in parallel without waiting initialization completion of a target device. However, when there is an order restriction, which is set in advance, between a component inside and a component, the order restriction is prioritized. The order restriction is an order restriction for initialization of the processor 101, and is determined in advance by the format generator 107 and stored in the memory 113 together with the message format as described above.

In the example described above, an initialization setting technique of writing a corresponding value into a register of the processor 101 is used, but other setting techniques may be used. For example, apparatuses which employ a technique of constructing a descriptor in a memory and transferring the descriptor through direct memory access (DMA) are commonly used. In this case, a method of constructing setting information in the memory 102 or the memory 113 and transferring setting information to a corresponding apparatus using DMA may be used.

As described above, in the present embodiment, the format of the start instruction message is shared in advance between the start instruction apparatus 201 and the communication apparatus 100. When the start instruction apparatus 201 desires to use a service of the communication apparatus 100 which is in a power off state, the start instruction apparatus 201 creates the start instruction message based on the format corresponding to a corresponding service and transmits the start instruction message to the communication apparatus 100.

The communication apparatus 100 supplies electric power to a component which is instructed to be powered on among components which configure the communication apparatus 100 to start the component while performing initialization, based on a content included in the received start instruction message. Since start and initialization of a component which is unnecessary for service provision are not performed, a standby time until a desired service is available can be reduced. Further, since electric power is not supplied to a component which is unnecessary for service provision, power consumption can be reduced.

As described above, according to the present embodiment, remote start can be rapidly performed, and power consumption can be reduced.

### Second Embodiment

Since a communication apparatus according to a second embodiment of the present invention has the same configuration as the communication apparatus 100 according to the first embodiment illustrated in FIG. 1, a duplicated description will not be repeated. The communication apparatus according to the present embodiment is partially different in processing performed inside from the first embodiment. Therefore, the different part will be described.

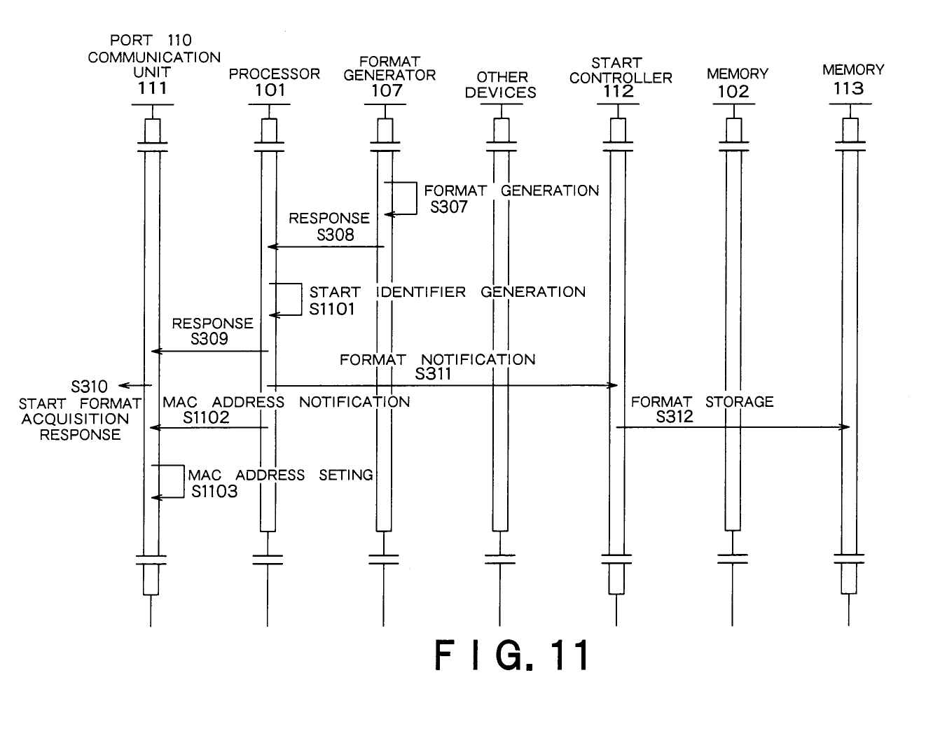

FIG. 11 illustrates part of an operation sequence of the communication apparatus according to the present embodiment. Compared to the first embodiment illustrated in FIG. 3, operation (step S301 to S306) until state checking of the respective components through the format generator 107 is identical and thus not illustrated in the drawing.

In the first embodiment, the processor 101 merely notifies the format generated by the format generator 107 to the communication unit 111 and the start controller 112.

However, in the present embodiment, when the processor 101 receives the format from the format generator 107, the processor 101 generates a start identifier based on the format (step S1101). For example, the processor 101 computes a hash value of the received format to generate a start identifier a predetermined length.

The start identifier generated in step S1101 is notified to the start instruction apparatus 201 together with the format (steps S309 and S310). Similarly, the start identifier is notified to the start controller 112 together with the format (step S311) and stored in the memory 113 (step S312).

Further, the processor 101 notifies all or part of the start identifier to the communication unit 111 as an MAC address (step S1102). The communication unit 111 sets the notified start identifier as its MAC address (step S1103).

At this time, whether or not the communication unit 111 can continuously use an MAC address which has been conventionally used depends on implementation. When the MAC address can be continuously used, the communication unit 111 receives packets through both MAC addresses.

However, when only one MAC address is designated, execution of steps S1102 and S1103 needs to be postponed until a power state changes. For example, in a state in which the start identifier is temporarily stored in the memory 102, when the processor 101 detects that a power state changes, steps S1102 and S1103 may be executed.

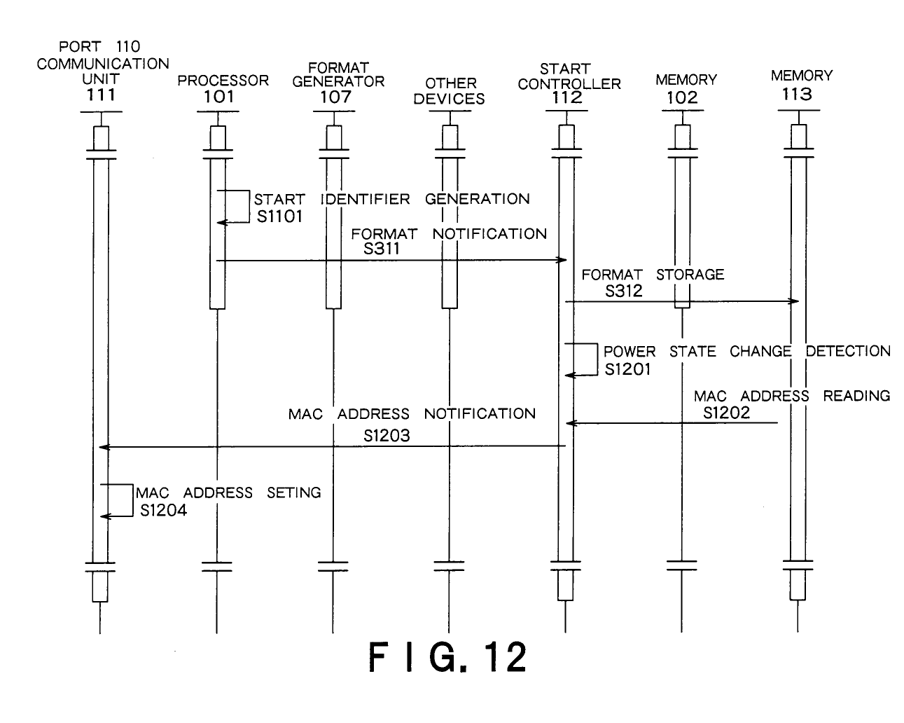

As illustrated in FIG. 12, the start controller 112 may detect that a power state of the processor 101 changes (step S1201), read out the start identifier stored in the memory 113 (step S1202) and notify the read start identifier to the communication unit 111 as an MAC address (step S1203). The communication unit 111 sets the start identifier notified from the start controller 112 as its MAC address (step S1204).

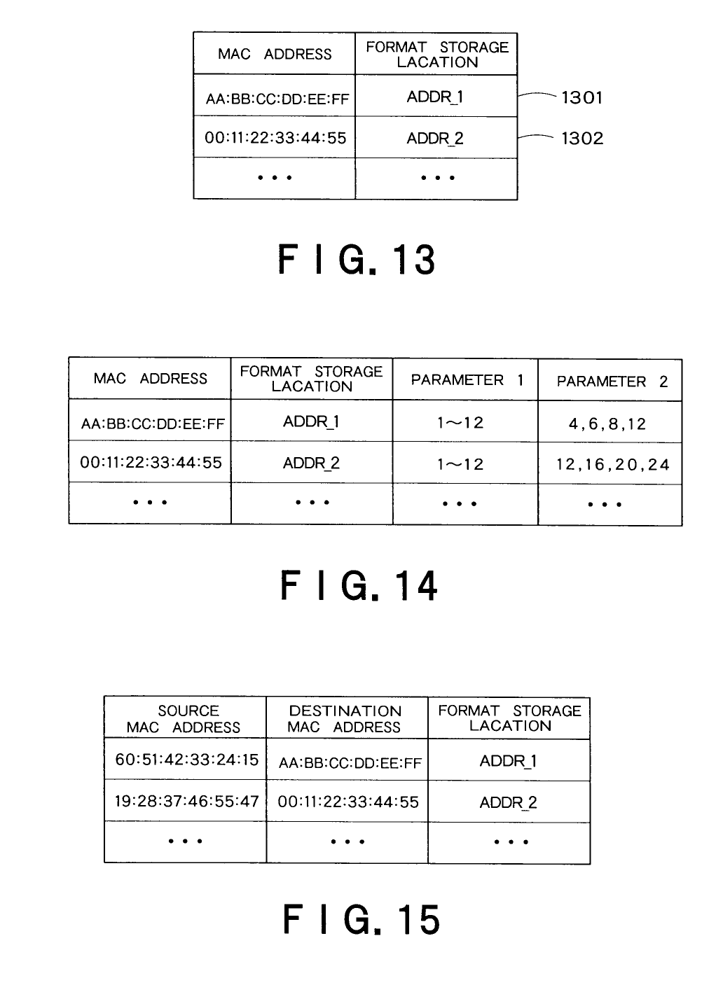

As described above, an MAC address which waits for the start instruction packet is an address which one-to-one corresponds with a message format. Therefore, in step S312, a message format and an MAC address (a start identifier) which are notified to the memory 113 are stored in one-to-one correspondence as illustrated in FIG. 13.

For example, in FIG. 13, row 1301 represents that a start instruction message which has “AA:BB:CC:DD:EE:FF” as an MAC address corresponds to a format stored at ADDR_1 of the memory 113.

Similarly, row 1302 represents that a start instruction message which has “11:22:33:44:55:66” as an MAC address corresponds to a format stored at ADDR_2 of the memory 113.

Further, as illustrated in FIG. 14, the MAC address may be stored in the memory 113 in association with a parameter which can be set by the start instruction apparatus 201.

Since the MAC address and the start instruction message corresponds one to one with each other, processing when the start instruction message is received is also extended. In detail, processing of steps S315 to S317 illustrated in FIG. 3 is changed.

In the first embodiment, since there is no particular correspondence relationship between the MAC address and the message format, in steps S315 and S316, a stored single message format is read out of the memory 113, and it is checked whether or not the read message format is identical to a corresponding message format.

However, in the present embodiment, the start instruction apparatus 201 transmits the start instruction message in which the start identifier received through the start format acquisition response is used as a destination MAC address. The start controller 112 which has received the start instruction message extracts the destination MAC address from the start instruction message and retrieves a message format stored in the memory 113 using a corresponding MAC address as a key. It is checked whether or not the message format acquired by the retrieval is identical to the received message.

As described above, according to the present embodiment, the message format and the MAC address can correspond one to one with each other, and a plurality of message formats can be used. Similarly to the first embodiment, remote start can be rapidly executed, and power consumption can be reduced.

Further, message reception through a plurality of MAC addresses is possible, and operation when the start instruction message in which the start identifier/the MAC address derived from the start instruction message is not used is received depends on a design. That is, start may be performed only through a message transmitted as an identifier based on a packet format which is precisely exchanged. For an Mac address which is not stored, start/initialization processing may be performed for all components.

### Third Embodiment

A third embodiment of the present invention is one in which the second embodiment is partially modified. In the second embodiment, the MAC address, used by the communication apparatus 100, which is derived from the message format is stored in the memory 113 in association with a corresponding message format. When the start instruction message is received, the memory 113 is retrieved using the destination MAC address included in the start instruction message as a key to acquire a corresponding format.

On the other hand, in the present embodiment, as illustrated in FIG. 15, an MAC address of the start instruction apparatus 201 which has transmitted the start format acquisition request is additionally stored in the memory 113 in association with the message format. When the start instruction message is received, two MAC addresses, that is, the destination MAC address and the source MAC address, are used to retrieve an appropriate format.

As a result, even when the start instruction message is received from a different node which has not notified the format of the start instruction message, the fact that the start instruction message is received from the node which has not notified a format can be early detected using the source MAC address. Therefore, more efficient processing than the second embodiment can be realized. Since a start instruction from the node which has not notified the format in advance can be rejected, stability of start processing can be improved.

In the second and third embodiments, an MAC address which is set to the communication unit 111 is derived from the format of the start instruction message using a hash algorithm. Therefore, when the message formats are identical, the same hash value may be derived several times.

For this reason, there is a possibility that an unauthorized user can improperly start the communication apparatus 100 re-using the start instruction message which has been transmitted from the formal start instruction apparatus 201 in the past.

In order to avoid the problem, when the MAC address is derived, a random number of a predetermined length or time information may be added before applying a hash algorithm.

When a plurality of communication apparatuses according to the second and third embodiments are present in the same network, there is a possibility that the MAC address derived from the format of the start instruction message using the hash algorithm is being used in a different apparatus.

In order to avoid the problem, after step S1101 described above, it may be checked using a protocol such as an address resolution protocol (ARP) whether or not the generated start identifier can be used as the MAC address.

As another resolution, an inquiry of an ARP about the MAC address derived from the format of the start instruction message may not be answered at all. As illustrated in FIG. 11, the start instruction apparatus 201 which starts the communication apparatus 100 using the notified message format may acquire the MAC address, which is waited by the communication apparatus 100, through prior communications. Therefore, the start instruction terminal 201 can be implemented not to invalidate the address, and in this case, an address resolution protocol such as an ARP does not need to be used.

In the second and third embodiments, the communication apparatus 100 derives the start identifier which is derived from the format of the start instruction message, and the derived start identifier is used as the MAC address of the communication apparatus 100 and notified to the start instruction apparatus 201. However, this processing may be performed separately in the communication apparatus 100 and the start instruction apparatus 201.

In this case, however, used hash algorithms need to coincide with each other. When a hash algorithm with a key is used, key information needs to be appropriately exchanged. When the random number or time information described above is added to derive a hash value, additional information needs to be exchanged or synchronized in advance. The information may be exchanged together with the start format acquisition request/response or may be exchanged through a separate means

### Fourth Embodiment

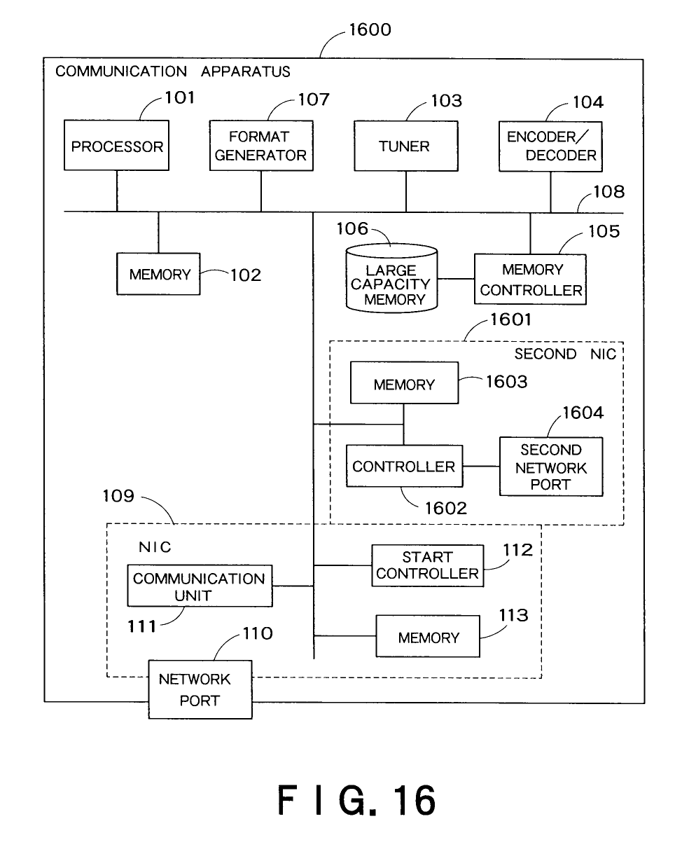

FIG. 16 illustrates a schematic configuration of a communication apparatus according to a fourth embodiment of the present invention. The communication apparatus 1600 according to the present invention has a configuration in which a second NIC 1601 is added to the configuration of the communication 100 according to the first embodiment illustrated in FIG. 1. Remaining components except the second NIC 1601 are identical to as in the first embodiment and thus are given the same reference numerals, and a duplicated description will not be repeated.

The second NIC 1601 includes a controller 1602, a memory (a second memory) 1603, and a second network port 1604.

The controller 1602 controls the second NIC 1601 and performs processing for starting the first NIC 109 when a signal identical to a start identifier designated in advance is received through the second network port 1604.

The memory 1603 stores a start identifier which the controller 1302 uses for determination. The memory 1603 is, for example, a RAM.

The second network port 1604 is a physical port for exchanging a message with the outside.

The second NIC 1601 has a feature in which it can operate with weak power but is not suitable for high speed communication. Weak power refers to a state in which electric power is not supplied from an apparatus body in which the communication apparatus 1600 is mounted, for example, electric power accumulated in a small battery or a capacitor. Weak power has a level in which an apparatus is operated with electric power generated by an electric wave input from the outside and a level in which an apparatus is operated with electric power lower than the first NIC 109.

For this reason, even though the communication apparatus 1600 is in a power off state, the second NIC 1601 can acquire a signal from the outside and perform an appropriate operation. The second network port 1604 is not limited to a wire-line network and may be implemented by an electrical or optical wireless network technique.

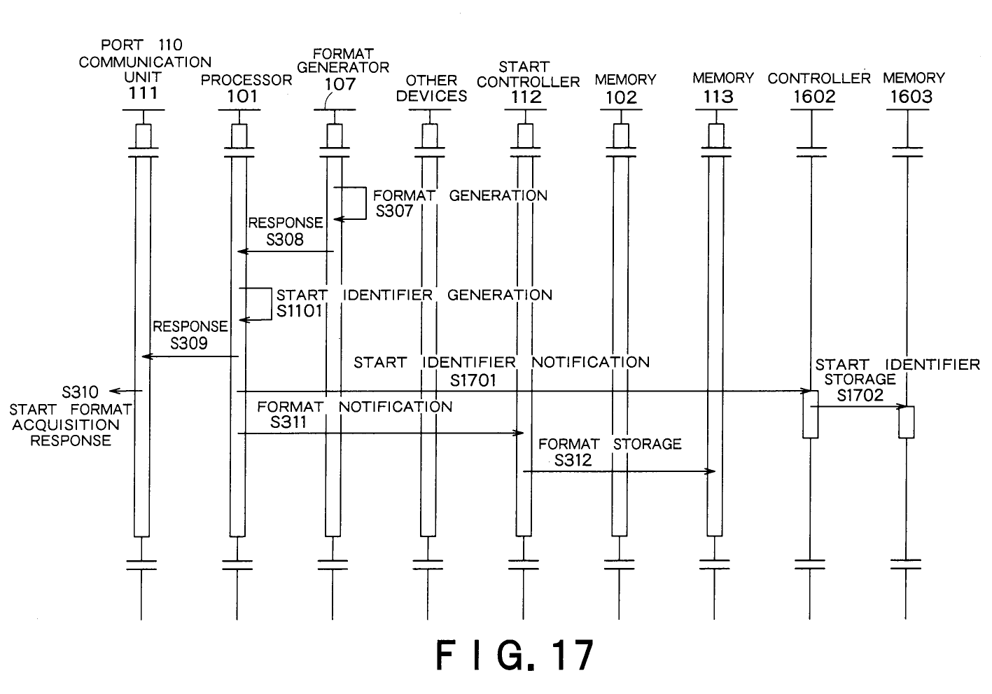

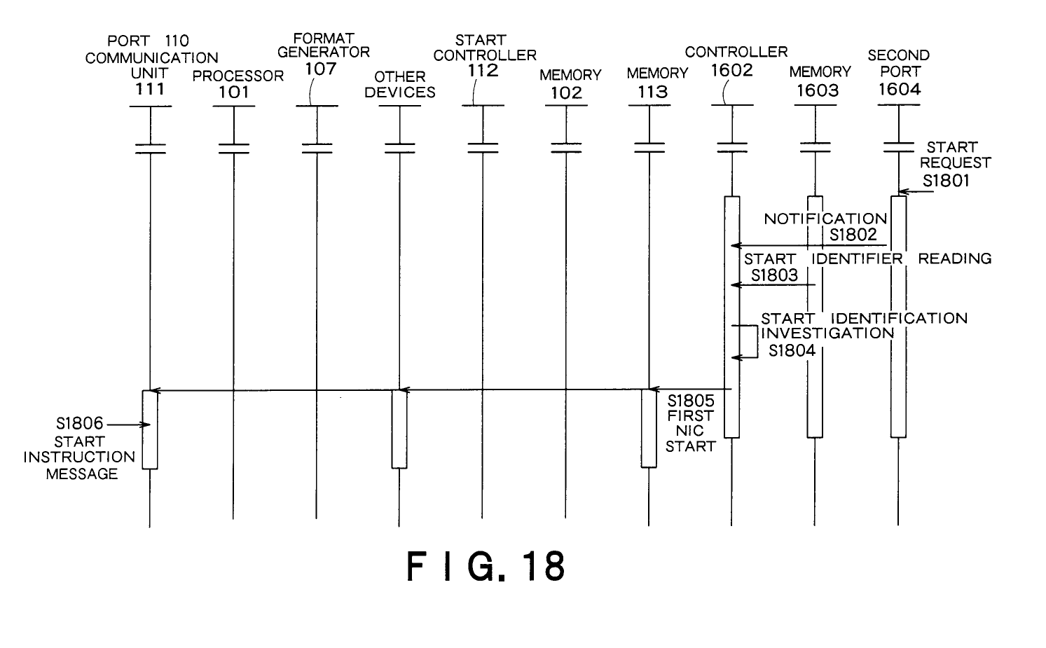

An operation sequence of the communication apparatus 1600 is illustrated in FIGS. 17 and 18. The operation sequence illustrated in FIGS. 17 and 18 is basically identical to the operation sequence of the second embodiment illustrated in FIG. 11, but is different in the fact that the start identifier derived from the format of the start instruction message is stored even in the memory 1603 and that all components of the communication apparatus 1600 are powered off after a series of processing for notifying the format of the start instruction message.

Similarly to the second embodiment, in step S1101, the start identifier derived from the format of the start instruction message is generated. In the second and third embodiments, the generated start identifier is notified to the start instruction apparatus 201, set as an MAC address and stored in the memory 113 through the start controller 112.

In the present embodiment, the start identifier is additionally stored in the memory 1603 through the controller 1602 (steps S1701 and S1702).

When the second NIC 1601 uses a start identifier of a size different from a start identifier (an MAC address) which can be used in the first NIC 109, the start identifier is re-converted into an appropriate format in step S1101, notified to the start instruction apparatus 201 and stored in the memory 1603.

When the start identifier is stored in the memory 1603, all power of the communication apparatus 1600 is turned off according to the feature of the second NIC 1601 described above.

Next, operation when start is instructed from the start instruction apparatus 201 will be described with reference to FIG. 18.

The second network port 1604 receives a start request transmitted from the start instruction apparatus 201 (step S1801). The start identifier stored in the memory 1603 in step S1702 is included in the start request. The start request is directly notified to the controller 1602 (step S1802).

The controller 1602 which is notified of the start request reads out the start identifier from the memory 1603 (step S1803). The controller 1602 investigates whether or not the start identifier included in the start request is identical to the read start identifier (step S1804). When the start identifier included in the start request is not identical to the read start identifier, the procedure is finished without performing subsequent processing. Here, it is assumed that the start identifier included in the start request is identical to the read start identifier.

When the start identifier included in the start request is identical to the read start identifier, the controller 1602 powers on the first NIC 109 (step S1805). Thereafter, the communication unit 111 receives the start instruction message through the network port 110 (step S1806). The start instruction message is identical to the start instruction messages which are received by the communication apparatuses according to the second and third embodiments. Therefore, subsequent processing is identical to as in the second and third embodiments, and a duplicated description will not be repeated.

As described above, the communication apparatus 1600 can power off all components after notifying the format of the start instruction message to the start instruction apparatus 201. Therefore, power consumption can be further reduced.

The communication apparatus according to the present embodiment can rapidly perform remote start in a manner similar to the first to third embodiments. Power consumption can be further reduced.

### Fifth Embodiment

A communication apparatus according to a fifth embodiment of the present invention employs a configuration similar to the communication apparatus 100 according to the second embodiment illustrated in FIG. 1 but is different in software which operates in the processor 101.

In the first to fourth embodiments, one communication apparatus which receives the remote start instruction from one node has been described as an example. In the present embodiment, a plurality of communication apparatuses which can be used at the same time for service provision is handled as a group, and the plurality of communication apparatuses is started together.

The present embodiment is different from the second embodiment in step of generating the start format, step of transmitting the start instruction message, and step of preparing for reception of the start instruction message. The different points will be described below in order.

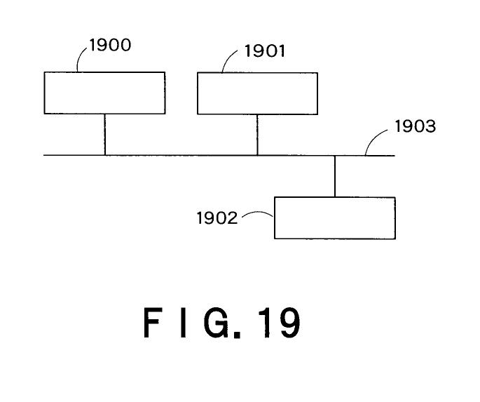

FIG. 19 is a schematic diagram of a network environment according to the present embodiment. Communication apparatuses 1900, 1901 and 1902 are connected via a network 1903. The communication apparatuses 1900 and 1901 are communication apparatuses having the same configuration as the communication apparatus 100. The communication apparatus 1902 is a communication apparatus which uses a service provided from the communication apparatuses 1900 and 1901 and a node which transmits a message for remotely starting the communication apparatuses 1900 and 1901.

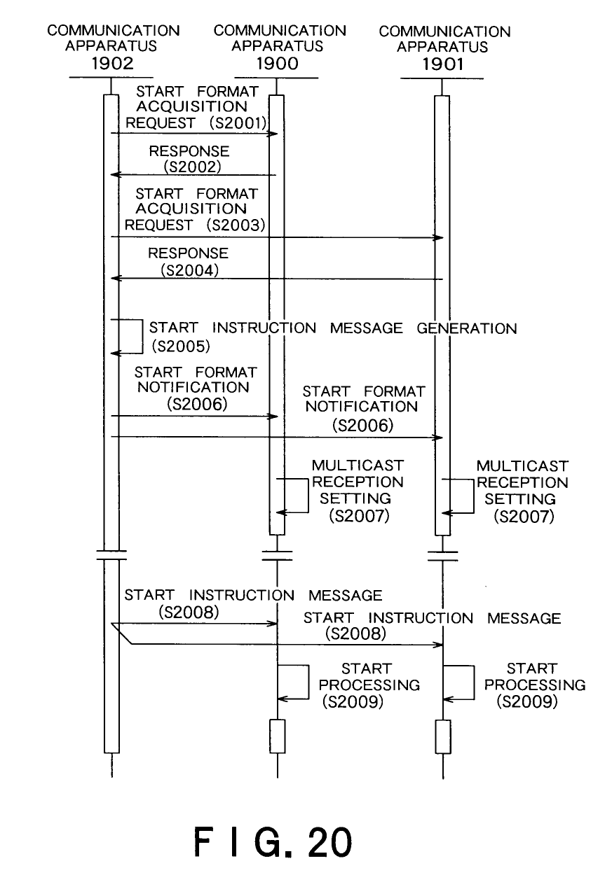

FIG. 20 illustrates an operation sequence between the communication apparatuses according to the present embodiment. This sequence is focused on operation of the respective apparatuses which can be observed from the outside and a message which is exchanged between apparatuses.

Here, the respective communication apparatuses are in an operation state. First, the communication apparatus 1902 (a communication apparatus which transmits the start instruction message later to execute remote start) transmits the start format acquisition request to the communication apparatus 1900 in a unicasting method (step S2001). The communication apparatus 1900 transmits the start format according to its internal state to the communication apparatus 1902 (step S2002).

The communication apparatus 1902 sequentially performs unicasting transmission of the start format acquisition request and acquisition of the start format with respect to all communication apparatuses which are to be started at the same time. Therefore, when the communication apparatus 1902 acquires the start format from the communication apparatus 1900, the communication apparatus 1902 performs the same processing with respect to the communication apparatus 1901 (step S2003 and S2004).

A procedure in which each communication apparatus which has received the start format acquisition request generates the format of the start instruction message for starting itself will be described later.

When the format exchange with all communication apparatuses is completed, the communication apparatus 1902 generates start instruction messages based on formats received from the respective communication apparatuses (step S2005). The communication apparatus 1902 notifies the generated instruction messages to the respective communication apparatuses 1900 and 1901 in a unicasting method (step S2006).

The respective communication apparatuses 1900 and 1901 which are notified of the start instruction messages change their reception setting based on the notified start instruction messages to be able to receive the remote start instruction transmitted in a multicasting method (step S2007). Internal operation of the communication apparatuses 1900 and 1901 at this time will be described later.

When the respective apparatuses 1900 and 1901 do not need to be continuously operated, the respective apparatuses 1900 and 1901 enter a power off state (a standby state).

Thereafter, the communication apparatus 1902 transmits the start instruction message which is exchanged in advance to a multicast address which is set in advance (step S2008). Since the respective communication apparatuses 1900 and 1901 are set to be able to receive a corresponding multicast address, the respective communication apparatuses 1900 and 1901 receive the start instruction message.

The respective communication apparatuses 1900 and 1901 which have received the start instruction message start start processing to power on themselves (step S2009).

The above-described operation is operation of the communication apparatuses 1900 and 1901 according to the present embodiment which is seen from the outside. As described above, the start instruction message is generated using information collected from the respective communication apparatuses and notified through a multicast message, thereby starting a plurality of communication apparatuses which are required to operate at the same time together. Since information suitable for the respective communication apparatuses is transmitted together, there is an effect of reducing a start processing time.

Next, operation of the communication apparatuses 1900 and 1901 will be described in detail. Only operation of the communication apparatus 1900 will be described below, but operation of the communication apparatus 1901 is identical to that of the communication apparatus 1900.

First, processing (processing performed between steps S2001 and S2002) performed when the communication apparatus 1900 receives the start format acquisition request will be described.

A start format acquisition request used in the present embodiment is partially different from the start format acquisition request used in the first to fourth embodiments. As described above, in the present embodiment, a final format of the start instruction message is determined based on formats acquired from a plurality of communication apparatuses (step S2005). For this reason, the message has to satisfy restrictions of communication apparatuses which are to be started at the same time. For example, since a packet size used for the start instruction message has an upper limit, when the number of communication apparatuses which are to be started at the same time increases, the amount of information which is available for one communication apparatus is reduced. Therefore, for example, measures for notifying the upper limit of the amount of information which is available for the respective communication apparatuses need to be taken.

In the first to fourth embodiments, the format transmitted as the response of the start format acquisition request is used as the start instruction message “as is”. However, in the present embodiment, the transmission side (the communication apparatus 1902) of the start instruction message generates the message based on the response. For this reason, when the message generated by the communication apparatus 1902 is received, the communication apparatus 1900 needs to be prepared for a subsequent actual start instruction. That is, the start format acquisition request is to instruct the communication apparatus 1900 to take such measures.

When the start format acquisition request is received, the communication apparatus 1900 generates the format in the same order as in FIG. 3. The generated format is a part of a final start instruction message. The generated format has to satisfy a condition (a length or a format) designated by the start format acquisition request.

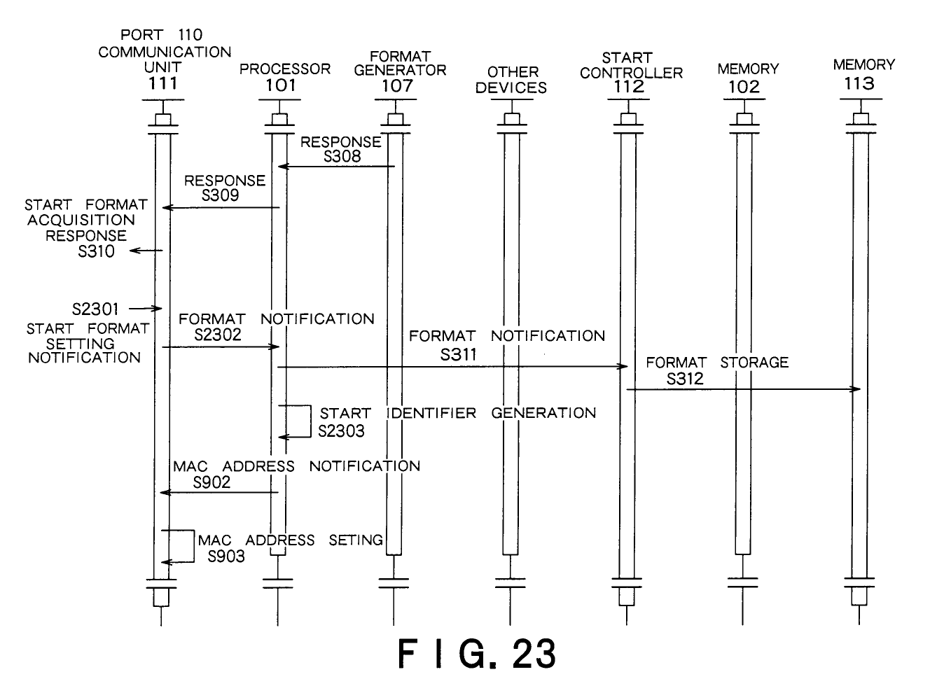

Operation of the communication apparatus 1900 which has transmitted the format is performed through two independent methods. A first method is a method of handling the start format acquisition request/response and subsequent processing as independent processing. In this case, as illustrated in FIG. 23, the communication apparatus 1900 waits for notification of the start instruction message without performing any processing after transmitting the format. Generation (step S2303) of the start identifier is performed after the final start instruction message (start format setting) is notified from the communication apparatus 1902 (step S2301).

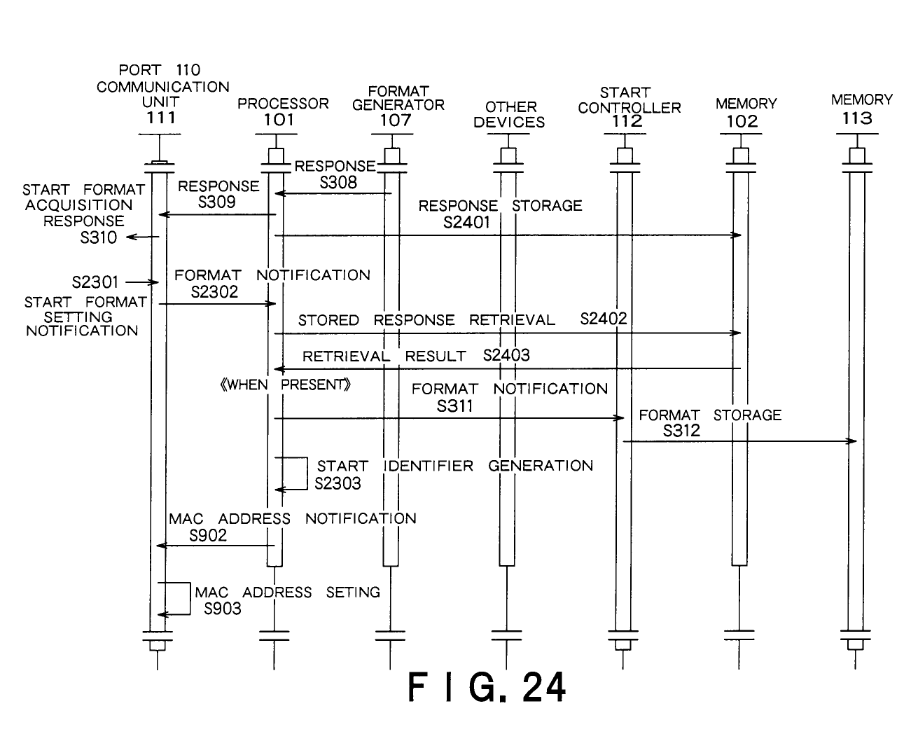

A second method is a method of handling a start format acquisition request/response and subsequent processing as single processing. In this case, as illustrated in FIG. 24, a content of the response or information (for example, an address) of a responding communication apparatus is stored and managed in the memory 102.

The above-described operation is processing which is performed inside the communication apparatuses 1900 and 1901 when processing of step S2001 to S2004 is performed.

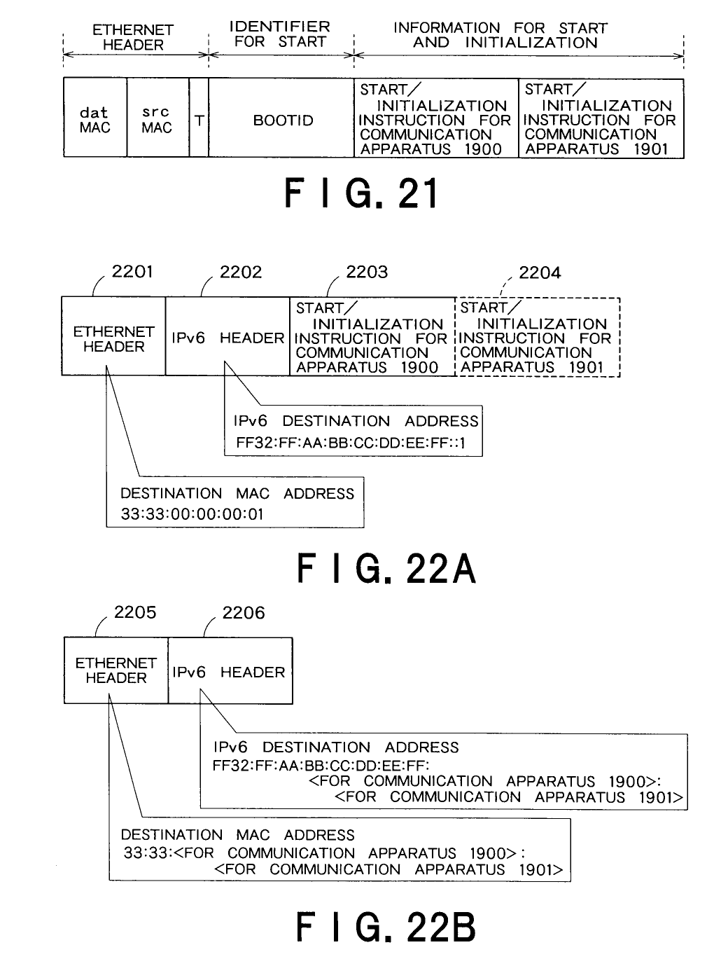

FIG. 21 illustrates an example of the start instruction message which is generated by the communication apparatus based on formats acquired from the two communication apparatuses. In the present embodiment, since it is assumed that the two communication apparatuses are simultaneously started as illustrated in FIGS. 19 and 20, the final start instruction message is greatly divided into three. One is a common part such as a header or a start ID, another is a part generated according to a format acquired from the communication apparatus 1900, and the other is a part generated according to a format acquired from the communication apparatus 1901.

The communication apparatus 1902 determines a multicast group and a multicast address corresponding thereto for transmitting the start instruction message to a plurality of target apparatuses together. The multicast address used at this time may be a multicast group and a multicast address which are previously corresponded to a function specified by the start instruction message, or an address which can be temporarily used by the communication apparatus 1902 which generates the start instruction message may be generated and used.

For example, as a group, “a multicast group for remote start which aims to watch TV broadcasting” or “a multicast group for remote start which aims to record TV broadcasting” may be considered. In the case of implementing the groups using an IPv6, a method specified in RFC4489 may be used, and, for example, a multicast address can be corresponded as follows.

TV broadcasting watching ff32: ff: <IID of communication apparatus 1902>:: 1/64

TV broadcasting recording ff32: ff: <IID of communication apparatus 1902:: 2/64

Here, IID stands for interface ID. 1 or 2 at the end denotes a group ID and corresponds to a function which is desired to be executed after a corresponding group starts. An address may be generated based on other appropriate formats.

Therefore, in the case of generating the multicast address in this manner, what a correspondence relationship which is determined in advance means a state in which information of a group ID has been exchanged in advance between the communication apparatus 1902 which generates and transmits the start instruction message and the communication apparatuses 1900 and 1901 which are to be started. On the other hand, a state in which a correspondence relationship is not determined in advance means a case in which a group ID is dynamically determined by the communication apparatus 1900. In both cases, when the communication apparatus 1900 notifies the start instruction message, an appropriate address is selected and notified together with the start instruction message.

Further, when a correspondence between a function and a multicast address is decided as described above, there is a case in which a component which has to be started in a communication apparatus or a parameter is decided at the time of the multicast address determination. In this case, the start/initialization instruction may be omitted for individual apparatuses (the format may be specified to omit it and transmitted as the response of the start format acquisition request).

On the other hand, a multicast group and address may be set without considering a correspondence relationship with a function. As an implementation example of a form using an IPv6, information according to the format acquired from each communication apparatus is stored in a group ID field. Since a group ID field has a 32-bit area, each communication apparatus can use 16 bits in this example. When the multicast group and address are generated as described above, a side which generates the start instruction message can make a decision without needing special knowledge.

FIGS. 22A and 22B illustrate an example of a multicast address generated by the above-described method. FIG. 22A illustrates a case of expressly using a correspondence relationship between a function and a group, and FIG. 22B illustrates a case of not using a correspondence relationship between a function and a group.

As illustrated in FIG. 22A, when a correspondence relationship between a function and a group is expressly used, an Ethernet header 2201, an IPv6 header 2202, and a start/initialization instruction 2203 for the communication apparatus 1900 are included. In this form, since a correspondence relationship between a function and a group is present, 1 is designated as a group ID similarly to the above-described example. A start/initialization instruction 2204 for the communication apparatus 1901 (which is a remote start target) drawn by a dotted line represents that start/initialization can be omitted when it is instructed through the notified format that start/initialization can be omitted. An MAC address corresponding to an IPv6 destination address is included in a destination address of the Ethernet header 2201.

As illustrated in FIG. 22B, when a correspondence relationship between a function and a group is expressly not used, an Ethernet header 2205 and an IPv6 header 2206 are included. In this form, since a correspondence relationship between a function and a group is not present, an IPv6 destination address is generated based on the format acquired from each communication apparatus. In this example, a start/initialization instruction is set based on a format of 16 bits notified from the communication apparatus 1900 and used as a group ID. An MAC address corresponding to an IPv6 destination address is stored in a destination MAC address.

Next, processing which is performed inside the communication apparatuses 1900 and 1901 when steps S2006 and S2007 of FIG. 20 are executed will be described.

After the response is transmitted to the communication apparatus 1902, the communication apparatus 1900 is on standby until the start instruction message is notified from the communication apparatus 1902. As described above, when the start format acquisition request/response and subsequent start instruction message notification are implemented as independent processing, the received start instruction message is stored “as is”. When the start format acquisition request/response and subsequent start instruction message notification are implemented as single processing, it is determined whether or not a source of the received start instruction message is identical to a response content or a response destination stored in the memory 102. When not identical, the notified start instruction message is discarded.

When the notified start instruction message is received, the message is stored in the memory 113 through the start controller 112. This processing is identical to as in steps S311 and S312 described in the first and second embodiments.

Processing corresponding to step S1102 and S1103 of the second embodiment needs particular measures for receiving the start instruction message transmitted in a multicasting method. That is, the communication unit 111 needs to be set to be able to receive an MAC address corresponding to a multicast group. Generally, a multicast address and an MAC address corresponding thereto can be uniquely derived. For example, as illustrated in FIGS. 22A and 22B, in the case of the IPv6, a multicast address and an MAC address corresponding thereto may be derived from lower 32 bits of an address.

Therefore, when the notification of the multicast group and address is received, the communication apparatus 1900 changes setting for receiving the MAC address corresponding to the multicast group through its communication unit 111.

According to the present embodiment, the start request and the initialization instruction can be transmitted together to a plurality of communication apparatuses which can be simultaneously used for service provision. Therefore, the plurality of communication apparatuses do not need to be sequentially started, and since start instructions and initialization instructions for individual communication apparatuses can be simultaneously transmitted, a start time can be reduced.

The fifth embodiment has been described through an example based on the second embodiment, but the third and fourth embodiments can be applied in a similar manner.

At least part of the communication apparatus described in the above embodiments may be implemented in either hardware or software. When implemented in software, a program that realizes at least part of functions of the communication apparatus may be stored on a recording medium such as a flexible disk or CD-ROM and read and executed by a computer. The recording medium is not limited to a removable recording medium such as a magnetic disk or optical disk, but may be a non-removable recording medium such as a hard disk device or memory.

The program that realizes at least part of the functions of the communication apparatus may be distributed through a communication line (including wireless communications) such as the Internet. Further, the program may be encrypted, modulated, or compressed to be distributed through a wired line or wireless line such as the Internet or to be distributed by storing the program on a recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus, comprising:
a generator which generates format information of a start instruction message;
a memory which stores the format information;
a communication unit which transmits the format information and receives a start instruction message via a network; and
a controller which detects whether or not the received start instruction message corresponds to the format information stored in the memory, and performs start processing and initialization processing based on a content of the start instruction message when the received start instruction message corresponds to the format information.

2. The apparatus according to claim 1, wherein the communication unit notifies information of an internal state of a corresponding communication apparatus to an external server via the network and receives a uniform resource identifier (URI) of a format generated by the external sever based on the information of the internal state from the external sever, and
the generator includes the URI in the format information.

3. The apparatus according to claim 1, further comprising a processor which computes an identifier based on the format information, wherein
the communication unit includes a network port and sets the identifier to the network port as an MAC address.

4. The apparatus according to claim 3, wherein the memory stores the format information in association with the identifier.

5. The apparatus according to claim 1, wherein the communication unit receives a generation instruction for the format information from a different communication apparatus and transmits the format information to the different communication apparatus via the network, and
the memory stores the format information in association with an MAC address of the different communication apparatus.

6. The apparatus according to claim 5, further comprising a processor which computes an identifier based on the format information, wherein
the communication unit includes a network port and sets the identifier to the network port as an MAC address, and
the memory stores the format information in association with the identifier and the MAC address of the different communication apparatus.

7. The apparatus according to claim 3, further comprising:
a second network port which operates with electric power lower than the network port and receives a start request when the controller, the network port and the memory are powered off;
a second memory which operates with electric power lower than the memory and stores the identifier; and
a second controller which operates with electric power lower than the controller, detects whether or not an identifier included in the start request is identical to the identifier stored in the second memory, and powers on the controller, the network port and the memory when the identifier included in the start request is identical to the identifier stored in the second memory.

8. The apparatus according to claim 1, further comprising a processor, wherein
the communication unit includes a network port, receives a generation instruction for the format information from a different apparatus and transmits the format information to the different communication apparatus via the network, and receives second format information which is generated by the different communication apparatus based on the format information, and
the processor computes an identifier set to the network port as an MAC address based on the second format information.

9. A method of starting a communication apparatus, comprising:
at a communication unit, receiving an acquisition request for a format of a start instruction message;
at a generator, generating a format based on an internal state;
at the communication unit, notifying the format;
at the communication unit, receiving a start instruction message corresponding to the format; and
at a controller, performing start processing and initialization processing for a component instructed by the received start instruction message among a plurality of components.

10. A computer-readable storage medium storing a program of starting a communication apparatus which causes a computer to execute the steps of:
at a communication unit, receiving an acquisition request for a format of a start instruction message;
at a generator, generating a format based on an internal state;
at the communication unit, notifying the format;
at the communication unit, receiving a start instruction message corresponding to the format; and
at a controller, performing start processing and initialization processing for a component instructed by the received start instruction message among a plurality of components.
